(19) United States
(12) Patent Application Publication
(10) Pub. No.: US 2010/0320237 A1
(43) Pub. Date: Dec. 23, 2010

(54) FLUID DISPENSING APPARATUS WITH LOCKABLE ACTUATOR

(75) Inventors: Balbir Raj, Bedford (GB); Matthew Rose, Hertfordshire (GB)

Correspondence Address: SWANSON & BRATSCHUN, L.L.C., 8210 SOUTHPARK TERRACE, LITTLETON, CO, 80120, US

(73) Assignee: ACCREDIT INNOVATIONS LIMITED, London (GB)

(21) Appl. No.: 12/486,618

(22) Filed: Jun. 17, 2009

(51) Int. Cl. B67D 5/40; B67D 5/33

(52) U.S. Cl. 222/384; 222/153.13

(57) ABSTRACT

One embodiment is a dispensing apparatus including a dispensing head for a fluid, wherein the dispensing head comprises an actuator, a pump mechanism and a locking member. The actuator is movable relative to the pump mechanism from a lock position to a first pump position and moveable relative to the pump mechanism between a first pump position and a second pump position for actuating said pump mechanism. The dispensing apparatus is configurable into a locked configuration, in which the actuator is in the lock position and in which the locking member is braced between the actuator and the pump mechanism to prevent movement of the actuator from the lock position, and an unlocked configuration in which the locking member allows movement of the actuator from the lock position, and wherein the dispensing head is adapted to revert from the unlocked configuration when the actuator is returned to the lock position. A biasing means in the form of a spring, elastic, gravitational or magnetic means may also be included as may a hinged locking member or a guide slot arrangement.

### BACKGROUND

Cleaning liquids, detergents, disinfectants, pesticides, polishes and other substances are available in containers and can be dispensed from the container through an aperture. These contents or substances range from those which are non-toxic to ones that are highly toxic. The aperture can be a nozzle or other aperture that is covered by a cap which when removed allows the substance to freely pass out of the nozzle upon squeezing or inverting the container. Alternatively, a pump mechanism can be used to actively push the substance out of the container through an aperture. The pump may be operated manually by a actuator mounted on the container. Containers having a pump mechanism for delivering the contents are known here-in as a dispensing apparatus. FIG. 1 shows a conventional dispensing apparatus with the pump mechanism and container. On coupling the pump mechanism to the container a conventional dispensing apparatus is produced.

A trigger or actuator that is manually or otherwise operated can actuate a pump mechanism to release the contents from the dispensing apparatus. Such actuators can be easily operated by adults, elderly or frail people as well as by children. To prevent children operating such dispensing apparatus they may be manufactured with a basic on/off switch mechanism which is intended to allow the dispensing apparatus to alternate between unlocked and locked configurations. In the locked configuration the contents cannot actively be released whereas in the unlocked state the contents may be released from the nozzle or output means. Such on/off mechanisms may include a flip-off cover which is positioned over the nozzle. When in place the cover prevents the release of liquid from the nozzle The cover has to be manually flipped away from the front of the nozzle turning the dispensing apparatus from an locked to an unlocked state. Once the operator has finished using the dispensing apparatus the cover is manually flipped back into place over the aperture of the nozzle, rendering the dispensing apparatus in a locked configuration. Other mechanisms include nozzles that are manually rotated as a means for alternating between the unlocked and locked configurations. Manipulation of the nozzles can also control the manner in which the substance is released, for example as a spray or continual stream of liquid or other intermediate form of release of substance may be produced.

The dispensing apparatus available today have many drawbacks, including:
Once the operator has finished using the dispensing apparatus, he or she must manually switch the dispensing apparatus from the unlocked state to the locked configuration. The operator may forget to do this, or may choose to leave the dispensing apparatus in the unlocked state. The dispensing apparatus can be left unattended in the unlocked state. A child finding the dispensing apparatus in an unlocked state could spray themselves or others with the substance.
These safety mechanisms can be difficult to operate especially for the elderly or those who have impaired manual dexterity. Such individuals may prefer to leave the dispensing apparatus in an unlocked state at all times hence defeating the object of the safety mechanism.
The safety mechanisms described above do not prevent the actuator being operated. In a locked configuration the mechanism may limit the release of substance during operation of the actuator. Whilst the substance may not actively be released from the nozzle it can accumulate within the vicinity of the nozzle and may leak out of the dispensing apparatus. Furthermore operation of the actuator mechanism with the dispensing apparatus in the locked configuration can lead to a build up of pressure within the container causing release of substance on switching the safety mechanism from the locked to the unlocked configuration.
Current dispensing apparatus suffer the disadvantage of being activatable if they are accidentally placed in a position against another object which could cause compression of the actuator. This results in the unwanted release of the contents from the container.
The action of switching the dispensing apparatus from an unlocked to a locked configuration is easily visible to a child who could learn and can copy it.

Various modifications of a dispensing apparatus operated by an actuator have been referred to in earlier descriptions. These are intended to prevent release of the contents by children. Some approaches seek only to prevent liquid from being released from the nozzle and do not prevent actuation of the actuator per se.

Examples of this approach are referred to in U.S. Pat. No. 4,346,821, JP2001-287763 and U.S. Pat. No. 516,695. These methods include rotatable or otherwise movable nozzles which are unlocked in one position and locked in another position or cover the nozzle using a cap or similar structure. These approaches can be combined. However, they do not prevent accidental or inappropriate squeezing or actuation of the actuator leading to possible leakage through the nozzle or pressure build up in the container. In practice repeated application of pressure to the actuator can result in leakage of the contents. These approaches also require that the operator returns the system to a safe position.

Further safety features added to rotatable or moveable nozzles which restrict their movement until the safety feature is moved in such a way as to allow the nozzle to be switched from a locked to unlocked state vice versa are provided. Such methods may make use of lugs and detents or other mutual engaging structures on the nozzle and body of the spray head. Engaging the lugs prevents activation of the nozzle but these approaches have the same disadvantages as those above and the additional burden of the operator having to use sufficient force to disengage the lugs, which an elderly or frail person may not be able to do or the lug structure becoming misshapen or worn after much use and then failing. For example EP0467554 describes a combination of lugs on the nozzle and detents on the dispenser body which when engaged prevent the actuator being actuated and are release by squeezing the nozzle skirt enabling the nozzle to be unthreaded to its unlocked position. The disadvantage of this is that a squeezing action may require a certain size and strength in the hands or fingers and the action may also require an additional unthreading action thus the activation of the nozzle requires two separate actions probably with both hands. Additionally after repeated squeezing the structure may become deformed thus limiting the effectiveness of the lug and detent system.

Another approach is referenced by U.S. Pat. No. 5,050,779 and similarly requires separate movements of small pieces around the nozzle to enable the nozzle to be move from an “OFF” position to an “ON” position. These features could be difficult for a person with limited digital mobility and could become clogged up in time to further limit the effectiveness of their operation. Another embodiment is found in U.S. Pat. No. 5,088,628 which has an overcap which has to be pulled away from the nozzle to enable operation of the nozzle. This could be a difficult maneuver to perform in some circumstances. U.S. Pat. No. 5,228,600 provides a similar embodiment but this requires that the body sides of the spray head are squeezed at the same time as the nozzle is rotated to enable the latter action to be undertaken. A nozzle locking mechanism can be slidable along the long axis of the nozzle as provided in U.S. Pat. No. 5,823,396 and requires the operator to slide it away from the nozzle to enable the nozzle to be rotated through its various positions. This is a complex action in practice and may be limited by manual strength and manual dexterity of the operator.

U.S. Pat. No. 5,477,989 discloses a nozzle cover which must be compressed around the rotatable cap to provide sufficient friction between the cap and the nozzle to enable the nozzle to be rotate by the operator. This operation suffers from similar drawbacks to the previous example. Another type of nozzle cover with a hook and cantilever arrangement wherein the hook on the nozzle cover is disengaged by pushing the cantilever and bending it downward is described in U.S. Pat. No. 556,404. This is a process that requires considerable manual dexterity.

U.S. Pat. No. 5,649,646 discloses a cover for the nozzle of a dispenser which has a complex catch arrangement to prevent the cover or door being removed from the nozzle before the catch is removed from the door or cover. Other embodiments of the concept are provided in U.S. Pat. No. 5,687,880, U.S. Pat. No. 5,706,983 and U.S. Pat. No. 6,186,366, U.S. Pat. No. 6,227,411, U.S. Pat. No. 6,478,193, U.S. Pat. No. 6,845,922 and a more complex locking means is described in WO9858872 which requires two separate movements to unlock the nozzle blocking plate before being able to actuate the device. The latter embodiment requires two actions one with each hand of the operator and thereby removing the operator of a hand to steady the whole container.

The general approach described above does not prevent activation of the dispensing mechanism and can result in liquid leaking from the nozzle or pressure being built up inside the container. Furthermore none of these embodiments will automatically return the whole spray head device to a safe position immediately after use.

A further example is EP0872283 which provides for a detent in the forward wall of the actuator or a notch in the rearward wall of the outercap, either of which locks the cap against the actuator until a slight depression of the actuator enables rotation of the cap to an unlocked position. This arrangement does not prevent the actuator being pulled back by a child or being accidentally pushed back on contact with another object. This could create pressure in the container and leakage of contents or sudden spray when the cap is rotated into its unlocked position. U.S. Pat. No. 4,257,561 describes a similar approach in which a slot in the rear of the nozzle engages a lug on the spray body. When the lug is depressed the nozzle can be actuated but this would require some manual dexterity and strength which an elderly person may not possess.

A different approach is to prevent the squeezing of the actuator. One example is by providing an arm radially extending from a rotatable structure about the cap of the container. When the actuator is compressed the radial arm prevents further compression but a locking means is released enabling rotation of the arm away from the actuator and allowing further compression. In practice this requires the operator to partially depress the actuator with one hand and release the arm with the other hand while maintaining pressure on the actuator until the actuator can be fully depressed. This is a complex process and could result in sudden release of contents when the arm is suddenly swung away from the actuator.

U.S. Pat. No. 441,633 provides a similar approach but in this case the actuator has to be pivoted in the direction opposite to its normal operation enabling the rotatable structure with side arm to be moved out of engagement with the actuator and enabling operation of the actuator in the normal direction of operation. This requires that the operator can move the actuator in two opposite directions in close succession which in practice could be difficult to achieve. Both these methods also require the operator to remember to return the actuator lock to it locking position after operation. U.S. Pat. No. 6,244,469 discloses a movable latch mechanism mounted on the actuator. This would require operation of the latch before and while operating the actuator. U.S. Pat. No. 6,286,723 provides for a similar and resetting latch mechanism. In this case the operator would need to provide force to the latch to prevent the lock from resetting during use.

A removable latch can be provided as in U.S. Pat. No. 5,823,396 but this requires the operator to return it to the safe position after use and has the risk of the latch being lost or broken after removal. If the latch is secured to the container it could interfere with the use of the device.

One embodiment which combines a locking means for preventing rotation of a rotatable cap and preventing movement of the actuator mechanism is described in U.S. Pat. No. 6,669,058 wherein a bar attached to the cap and when in the “OFF” position is also removably attached to the actuator is moved in a direction such that it disengages from the actuator enabling operation of the actuator and simultaneously rotates the rotatable nozzle into an “ON” position. However, this bar could hinder operation of the device and is susceptible to breakage when disengaged from the actuator.

A way of overcoming the disadvantage of not automatically returning the whole device to the safe position is proposed in U.S. Pat. No. 5,114,049 in which the actuator has a pivotally mounted latch which has an arm projecting forward of the actuator to enable release of the latching mechanism. However this arrangement may have some of the disadvantages described above.

A further variant of incorporating a child-proof safety feature into a spray head is the introduction of a valve within the dispensing mechanism as in U.S. Pat. No. 4,982,900 such that slow squeezing of the actuator envisaged as by a child causes the contents of the container to return back to container whereas rapid squeezing will enable dispensing of liquid through the spray nozzle. This however does not account for children with the ability to produce enough force to cause dispensing of liquid though the nozzle or elderly or frail people not being able to operate the actuator with sufficient force to dispense liquid through the nozzle.

A rotatable actuator cover is provided in U.S. Pat. No. 7,032,777 which overlies the front face of the actuator to prevent actuation and is rotated away exposing the front face to facilitate grasping of the actuator and actuation. The cover can be locked in position but would need to be replaced by the operator after use.

Many of the above solutions to provide safety features involve extensive modifications to the existing dispensing apparatus in particular to the pump mechanism. This can for example involve design modifications made to the internal and external structures forming the pump mechanism. Such drastic modifications to the pump mechanism are not always welcomed by manufacturers who will consider the cost of changing the design of the pump since they are selling their products in a commodities market.

The present invention is directed toward overcoming one or more of the problems discussed above.

### SUMMARY OF THE EMBODIMENTS

One embodiment is a dispensing apparatus including a dispensing head for a fluid, wherein the dispensing head comprises an actuator, a pump mechanism and a locking member. The actuator is movable relative to the pump mechanism from a lock position to a first pump position and moveable relative to the pump mechanism between a first pump position and a second pump position for actuating said pump mechanism. The dispensing apparatus is configurable into a locked configuration, in which the actuator is in the lock position and in which the locking member is braced between the actuator and the pump mechanism to prevent movement of the actuator from the lock position, and an unlocked configuration in which the locking member allows movement of the actuator from the lock position, and wherein the dispensing head is adapted to revert from the unlocked configuration when the actuator is returned to the lock position. A biasing means in the form of a spring, elastic, gravitational or magnetic means may also be included as may a hinged locking member or a guide slot arrangement.

### BRIEF DESCRIPTION OF THE DRAWINGS

FIG. 1—Side elevation view of a prior art dispensing apparatus

FIG. 2a—Side elevation view of an actuator as disclosed herein, shown in locked position

FIG. 2b—Side elevation view of an actuator shown in unlocked position.

FIG. 3a—Side elevation view of an actuator shown in locked position.

FIG. 3b—Side elevation view of an actuator shown in unlocked configuration

FIG. 4—Side elevation view of an actuator shown in locked position.

FIG. 4a—Side elevation view of an actuator shown in unlocked configuration.

FIG. 5a—Side elevation view of a locking member placed vertically against actuator.

FIG. 5b—Side elevation view of an actuator shown in unlocked (active) position.

FIG. 6—Perspective view of a locking member as disclosed herein.

FIG. 6a—Perspective view of a locking member.

FIG. 6b—Perspective view of a locking member.

FIG. 7a—Side elevation view of a locking member actuator shown in locked position.

FIG. 7b—Side elevation view of an actuator shown in unlocked configuration.

FIG. 8b—Perspective view of a linking member.

FIG. 9a—Side elevation view of an actuator shown in locked position.

FIG. 9b—Side elevation view of an actuator shown in unlocked position

### DETAILED DESCRIPTION

This application discloses alternative means to improve the safety aspects of a dispensing apparatus that utilise a pump mechanism to generate the release of the contents. The various embodiments as shown in the figures and described herein include, but are not limited to the following:

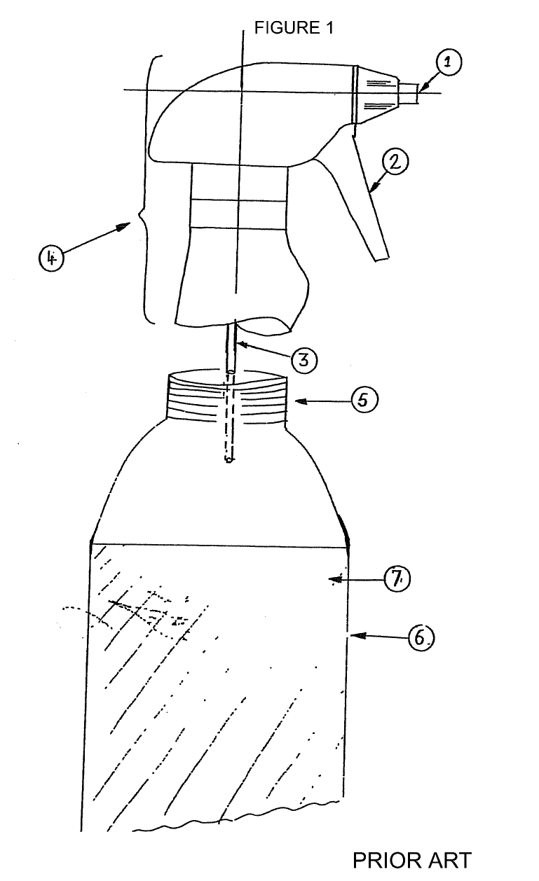

FIG. 1—Side elevation view of a prior art dispensing apparatus, including;

Element 1—nozzle

Element 2—actuator

Element 3—inlet

Element 4—pump mechanism

Element 5—screw neck

Element 6—container

Element 7—reagent

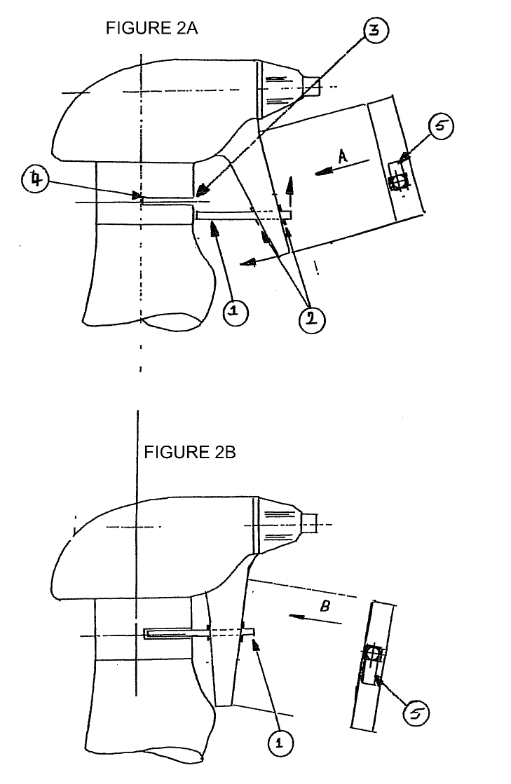

FIG. 2a—Side elevation view of an actuator as disclosed herein, shown in locked position (locked configuration), including;

Element 1—locking member

Element 2—overhang/flange

Element 3—aperture

Element 4—channel

Element 5—guide slot

FIG. 2b—Side elevation view of an actuator shown in unlocked position, including;

Element 1—locking member

Element 5—guide slot

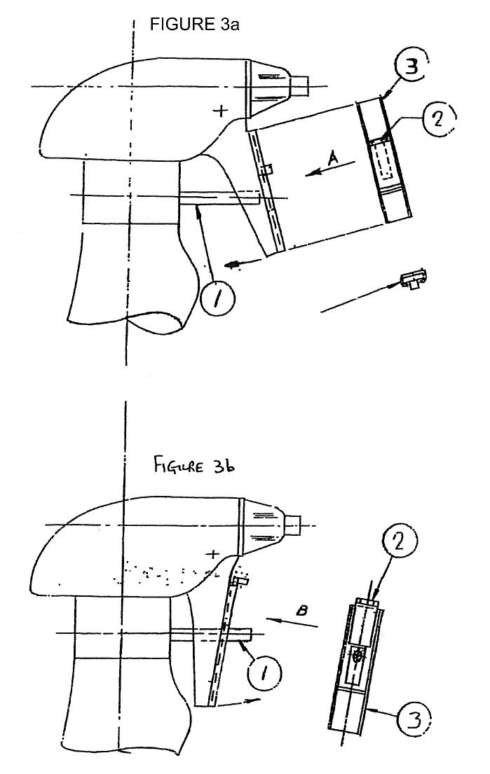

FIG. 3a—Side elevation view of an actuator shown in locked position, including;

Locking member held near body of container. Actuator movement is enabled by raising shutter/slider on actuator allowing locking member to pass through aperture.

Element 1—actuator

Element 2—slider

Element 3—slider guide

FIG. 3b—Side elevation view of an actuator shown in unlocked configuration, including;

Element 1—actuator

Element 2—slider

Element 3—slider guide

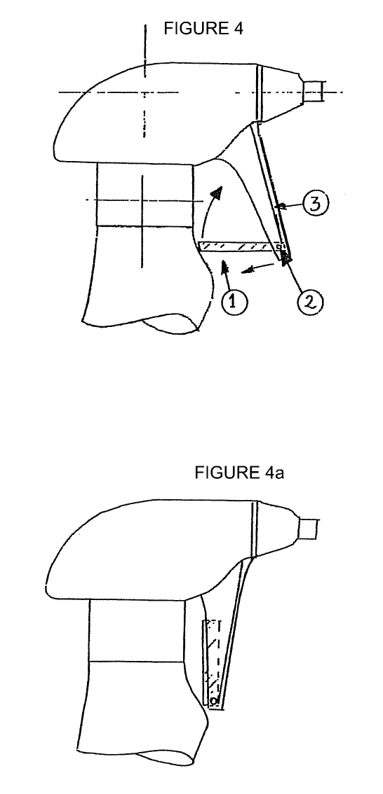

FIG. 4—Side elevation view of an actuator shown in locked position

Locking member attached to bottom of actuator & rotated about a hinge. Biasing means automatically returns locking member to locked position

Element 1—locking member

Element 2—hinge

Element 3—biasing means

FIG. 4a—Side elevation view of an actuator shown in unlocked configuration, including;

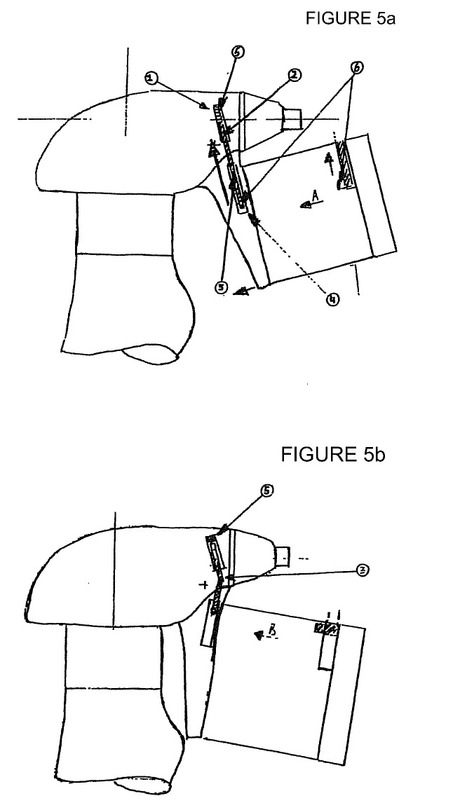

FIG. 5a—Side elevation view of a locking member placed vertically against actuator (actuator shown in locked configuration.) Lever 6 passes through channel between retaining flanges which are not shown, including;

Element 1—guide tube (upper)

Element 2—locking member

Element 3—hinge region

Element 4—guide tube (lower)

Element 5—biasing means

Element 6—lever

FIG. 5b—Side elevation view of an actuator shown in unlocked (active) position, including;

Element 3—hinge region

Element 5—biasing means

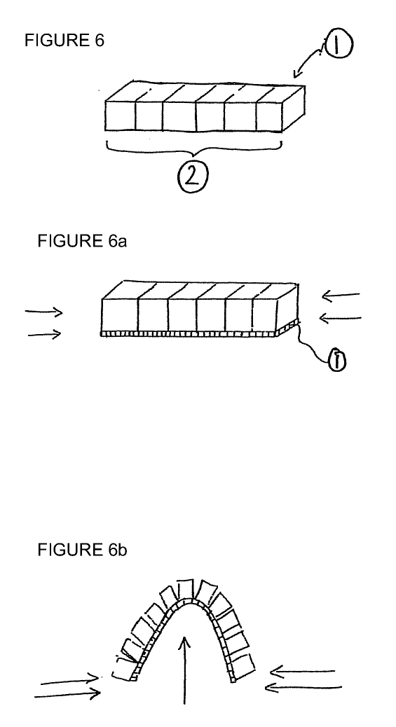

FIG. 6—Perspective view of a locking member as disclosed herein, including;

Element 1—segments

Element 2—locking member

FIG. 6a—Perspective view of a locking member, including;

Compression shown by the arrows does not produce significant deformation of the locking member.

Element 1—adhesive tape

FIG. 6b—Perspective view of a locking member, including;

Force applied to the adhesive tape whilst the locking member is compressed at the sides

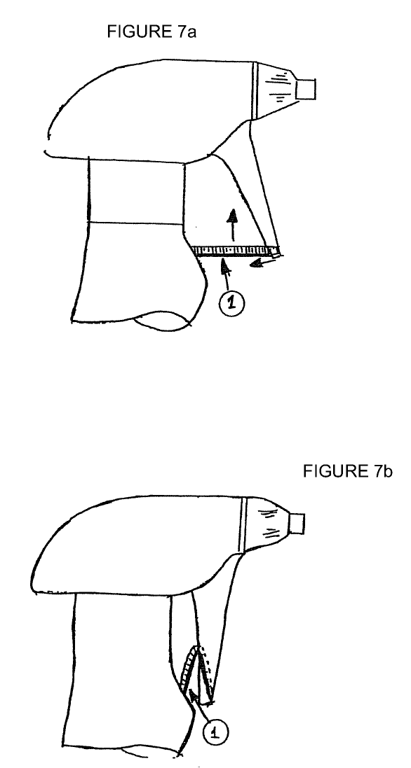

FIG. 7a—Side elevation view of a locking member actuator shown in locked position, including;

Locking member is comprised of segments which when displaced upwards or downwards (up only shown) with sufficient force allows locking member to deform allowing actuator to be operated.

Element 1—segmented locking member—composed of separated segments attached to adhesive tape or similar backing

FIG. 7b—Side elevation view of an actuator shown in unlocked configuration.

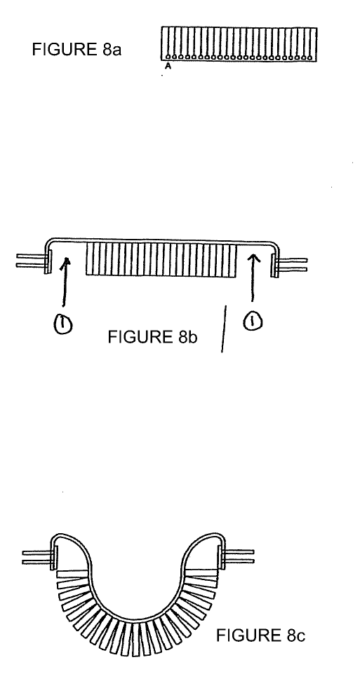

FIG. 8b—Perspective view of a linking member, including;

Element 1—linking piece(s)

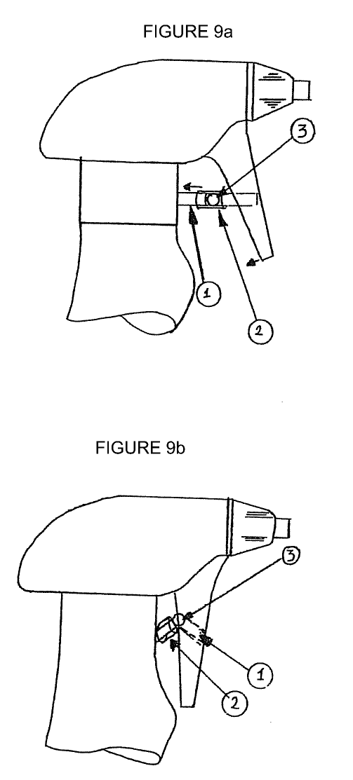

FIG. 9a—Side elevation view of an actuator shown in locked position, including;

Brace 2 prevents locking member from bending at hinge or pivot. The brace is slid along locking member, allowing locking member to bend at hinge or pivot enabling actuator to be become unlocked.

Element 1—locking member

Element 2—slidable tube

Element 3—pivot/hinge

FIG. 9b—Side elevation view of an actuator shown in unlocked position, including;

Element 1—locking member

Element 2—slidable tube

Element 3—pivot/hinge

The improved dispensing apparatus comprises a dispensing head for a fluid, wherein the dispensing head comprises an actuator, a pump mechanism and a locking member, wherein the dispensing apparatus can alternate between a locked configuration and an unlocked configuration. A distinguishing feature is that the new locking member automatically returns the dispensing apparatus to the locked configuration upon the release of the grip on the actuator. The dispensing apparatus may further comprise a container for containing the fluid to be dispensed, in fluid connection to said dispensing head.

The improved dispensing apparatus are enabled by little or no modifications to existing dispensing apparatus since the improvement may be added to existing structures. For instance such modifications are enabled through the addition of a low cost structure being something as simple and cost effective as a piece of moulded plastic.

The advantages of the improved dispensing apparatus include;
the dispensing apparatus cannot be left unattended in an unlocked configuration.
once the operator has finished using the dispensing apparatus there is no need for them to remember to physically switch the dispensing apparatus from the unlocked to the locked configuration.
the action of the operator totally releasing their grasp on the actuator switches the locking member into operation converting the dispensing apparatus from the unlocked to the locked configuration.
the mode of operation of the locking member is not easily visible to a child and it is therefore difficult for a child to defeat it.
the on/off switches that are currently used are in on aspect made redundant as the improved safety dispensing apparatus also provides such a switch, however with additional advantages. Even so the improved dispensing apparatus and conventional safety switches can be used conjointly as a means to provide further protection.
Left or right handed individuals can operate the improved safety features.

The operator does not have to hold the locking member in the unlocked configuration to prevent the apparatus from returning to the locked configuration.

The dispensing apparatus is switched from a locked configuration to an unlocked configuration when the operator grasps the dispensing apparatus in a particular manner. It is quite easy for an adult to learn how to do this. However, since there is no obvious switching mechanism visible to a child it is difficult for a child to easily perform the correct grasping action. In addition, the correct grasping action is counter-intuitive and as such a child will not readily perform the required grasping action.

In one embodiment the locking member prevents or minimises the movement of the actuator. As a result the pump mechanism that is used to deliver the substance to the nozzle cannot function and as such the dispensing apparatus remains in a locked configuration. Since the pump mechanism cannot be actuated when the dispensing apparatus is in a locked configuration, there can be no build up of pressure within the container.

A physical means for preventing the operation of the actuator thereby locking the dispensing apparatus may be utilised. FIG. 2a shows one embodiment of the physical means by which the actuator is prevented from being operated. This can be a piece of material that is present within the space between the actuator and the dispensing head or container (FIG. 2a), for example between the actuator and the pump mechanism wherein the pump mechanism may further comprise a housing. When the piece of material is occupying the space between the actuator and the dispensing head or container the movement of the actuator is restricted or prevented. Since the pump mechanism cannot be operated, the contents cannot be released and the dispensing apparatus is in the locked configuration. The material occupying the space between the actuator and the dispensing head or container is known as the locking member. The exact position, shape and orientation of the locking member are not important as long as it functions to minimise or prevent the action of the pump mechanism. When the locking member is positioned such that it prevents or minimises the movement of the actuator, it is said to be in the starting position. When the actuator is not being handled and the dispensing apparatus is in the locked configuration, the actuator is said to be in the locked or starting position. When the dispensing apparatus is in the unlocked configuration, the actuator is moveable relative to the pump mechanism from the locked position to a first pump position, and is moveable relative to the pump mechanism between the first pump position and a second pump position to actuate the pump mechanism.

FIG. 2a shows the locking member in the starting position where the movement of the actuator is prevented or reduced and the dispensing apparatus is in a locked configuration. The locking member can comprise any rigid material, being natural material such as wood, metal or any man-made material such as a plastic or a composite of these.

Converting the Dispensing Apparatus from a Locked to an Unlocked Configuration.

There are various ways in which the improved dispensing apparatus may be converted from the locked configuration to the unlocked configuration. Some examples are provided below.

In one example the locking member is moved manually by the operator from its starting position to a position where movement of the actuator between the first and second pump positions is allowed and contents are dispensed (FIG. 2b). The locking member automatically remains in this position until the actuator is returned to the locked position. When the user releases their grip on the actuator, the actuator returns to the locked position and the locking member automatically returns back to the starting position, (FIG. 2a), locking the dispensing apparatus. The operator does not need to manually switch the dispensing apparatus from the unlocked to the locked configuration.

There are various ways of returning the locking member back to its staring position including but not limited to the influence of gravity, elastic, magnetic, spring biased means or other methods. The manner with which the operator grasps the dispensing apparatus plays a crucial role in determining whether or not it is switched from the locked configuration to the unlocked configuration. The operator must grasp the dispensing apparatus in such a way as to move the locking member from the starting position to a position in which movement of the actuator between the first and second pump positions is allowed. This is a key feature in the childproof properties of the improved dispensing apparatus.

During use of the dispensing apparatus the user does not need to release the actuator fully to the lock position. The actuator may be moved between the first and second pump position to allow repeated actuation of the pump mechanism without returning the dispensing apparatus to the locked configuration. A child however having fully released the actuator to the lock position will lock the dispensing apparatus as the locking member returns back to its starting position. The child may not remember how to repeat the actions which lead to the release of the substance in the first instance. In such an event the amount of substance released from the dispensing apparatus by the child is limited to a single actuation.

On fully releasing the actuator such that it returns back to its lock position, the locking member returns back to its starting position where it prevents the operation of the actuator.

### EXAMPLES

The following examples are provided for illustrative purposes only and are not intended to limit the scope of the invention.

### Example 1

In example 1 the locking member is rigid against movement of the actuator from the lock position. A section of the locking member passes through the actuator to produce an overhang on the actuator (FIG. 2a). The locking member cannot move laterally through the actuator. When the locking member is in the starting position, it is placed between the actuator and the pump mechanism (FIG. 2a). In this position the locking member prevents or minimises the movement of the actuator, preventing or reducing the operation or actuation of the pump mechanism. The locking member can be slid up and down whilst it is maintained in a horizontal or near horizontal orientation. A channel that is created within the actuator itself enables this. This channel allows for the vertical movement of the locking member but little or no lateral movement of the locking member through the actuator. Various means to reduce the lateral movement of the locking member through the actuator can be used. An example of which is a protrusion on the locking member that prevents the lateral movement of the locking member through the actuator. Specific moulding features within the locking member and the actuator could maintain the horizontal positioning of the locking member. These features help prevent the locking member from falling downwards at the container end of the locking member, maintaining it in a horizontal or near horizontal position.

When the locking member is raised to a specific position it becomes aligned with an aperture or opening within the dispensing head or container, (FIG. 2b). The aperture allows the locking member to travel into the dispensing head or container. The operator manipulates the locking member in alignment with the aperture and then actuates the actuator. Since the locking member is allowed to move into the aperture, the actuator can be moved from the lock position to the first pump position, and between the first and second pump positions. The locking member remains in alignment with the aperture until the actuator is moved to the lock position.

When the operator has finished using the dispensing apparatus the operator releases their grip on the actuator, the actuator returns to the lock position, the locking member travels by gravity or by a biased, (elastic, spring etc) means back to its starting position rendering the dispensing apparatus in the locked configuration.

The exact position of the channel in the actuator that occupies the moving locking member is not critical to its action.

The user can for example run their fingers along the front side of the actuator and raise the locking member. On raising the locking member to be in alignment with the aperture, the user grasps the actuator and actuate it and thus dispenses the substance. The operator can continue to dispense substance as long as the locking member is in alignment with the aperture.

Left as well as right-handed individuals can operate the safety mechanism. Since the means by which the dispensing apparatus is converted from the locked configuration to the unlocked configuration requires a sleight of hand, it is not easy for a child to perceive the means for doing this. A child is unlikely to raise the locking member to operate the actuator.

The locking member may be lowered into alignment with an aperture. Again the locking member is biased to return to its starting or raised position by elastic, magnetic or other means once the user releases their grip on the actuator to return it to the lock position.

### Example 2

The locking member may alternatively be raised into alignment with an aperture in the actuator, termed the actuator aperture. In this case the locking member has a first and second end wherein the first end does not move or has limited movement and wherein the second end is manipulated into alignment with the aperture in the actuator. In the locked configuration, the second end of the locking member is misaligned with the aperture in the actuator and thus the actuator cannot be operated. The user has to push the second end of the locking member into alignment whilst the actuator is pressed. The locking member once aligned with the aperture is able to pass outwards through the actuator and past the fingers of the operator. On release of the actuator, the locking member returns back to its starting position and returns the dispensing apparatus to the locked configuration.

In yet another embodiment, the locking member is positioned between the pump mechanism and the actuator in an orientation that prevents or restricts the movement of the actuator. In this embodiment the locking member is fixed, held or restrained at the end that is nearest the pump mechanism. The locking member is however, not fixed at the actuator end (FIG. 3). An aperture is present in the actuator which is of sufficient size and shape to enable the locking member to pass through the aperture in the actuator on operating the actuator. A shutter is present within or on the actuator itself. The shutter is comprised of a material that can prevent penetration of the locking member through the actuator and can be made of any appropriate material. The shutter is configured to open and close the aperture.

When the dispensing apparatus is in the locked configuration the shutter is down, (in its lowered position) and covers the aperture in the actuator, closing the aperture. In this position the actuator cannot be operated since the locking member cannot pass through the aperture in the actuator; the dispensing apparatus is in the locked configuration (FIG. 3a). Raising the shutter in a manner that uncovers and opens the aperture within the actuator can allow the passage of the locking member into the aperture, (FIG. 3b). The shutter may be orientated in any direction and may be linear, circular or any other appropriate shape.

Means for allowing the raising of the shutter are provided for example by the shutter being lipped over at the upper end or having one or more protrusions somewhere along its length or around its circumference. The lip produces an overhang allowing the shutter to be raised by the finger(s) of the user. The shutter may be slidably mounted to the actuator and may slide up and down on a guide, the guide may be created in various ways either as part of the actuator or as a structure adhered to the actuator.

In this example the operation of the actuator results in a portion of the locking member moving through the actuator and into the gaps present between the fingers of the operator. An adult would be able to accommodate such a feature whereas a child may find this difficult. In the event that a child manages to move the shutter up and operate the actuator they may feel the locking member push against their fingers, which they may find uncomfortable. This could result in the child loosing their grip of the dispensing apparatus. In this event, the dispensing apparatus returns to the locked configuration.

The shutter is arranged such that it returns to its lower position automatically when the actuator is returned to the lock position. This downward or return movement is automatic; the user does not have to remember to physically do this. In the lowered or closed position the shutter blocks the aperture in the actuator thereby preventing movement of the locking member through the aperture. There are various ways in which the shutter can be returned back to its lowered or shut position, including the influence of gravity, spring, elastic, magnetic or other means.

The shutter may also have one or more apertures through which the locking member can pass. In this instance the locking member would have to be aligned with the aperture in the actuator as well as the aperture(s) in the shutter. The locking member could be forked at one end.

While the shutter may be a flat plate that slides along a shutter guide it may also be of the form of a rotating rod through which a aperture is bored. In the locked configuration said aperture(s) are not lined up with the locking member, preventing passage of locking member through the actuator and thus preventing operation of the actuator. After rotation of the rod, said aperture(s) in the rotating rod align with the locking member enabling passage of locking member and normal operation of the actuator mechanism. On releasing the grip on the actuator, the rotating rod returns back to its position where the aperture(s) in the rotating rod are not aligned with the locking member.

The shutter may be of the form of a flat rotating plate, which blocks passage of the locking member. The rotational movement of shutter aligns an aperture in the shutter with the locking member, enabling operation of the actuator as before. In all instances the shutter mechanism for preventing movement of the actuator relative to the locking member automatically returns to a state that renders the dispensing apparatus locked when the individual loosens their grip on the actuator and returns the actuator to the lock position. The locking member may have notches along its length which are designed to engage the shutter if it is not raised fully. In this way the shutter must be raised and maintained by a specific height for the dispensing apparatus to remain in the unlocked configuration. Slight downward movement of the shutter results in the shutter engaging with the notches in the locking member thus preventing actuation or squeezing of the actuator and locking the dispensing apparatus.

Other variants include dispensing apparatus that require the shutter to be moved downwards in order for the locking member to be aligned with the aperture in the actuator, or an aperture on the shutter. Once the user has finished with the dispensing apparatus the shutter automatically returns to its starting position where it blocks the movement of the locking member through, rendering the dispensing apparatus locked.

The outer face of the actuator or the actuator itself may incorporate a receiving chamber into which the locking member passes thus protecting the operator from contact with the locking member. The chamber can be made from any material that is natural or man made and may be any size or shape sufficient to receive all or part of the locking member.

The shutter may be present at the container end of the dispensing apparatus and the locking member fixed to the actuator. Upon correct operation, the movement of the locking member is towards the user and the locking member does not pass through the vicinity of the users fingers.

These descriptions of the child locking member are not definitive and may take other forms according to design requirements.

Dispensing apparatus can be designed to have apertures that can accommodate a moving locking member. It is apparent to the person skilled in the art that the examples described above can be made by adhering structures to the actuator, dispensing head or container or the pump mechanism. In example 1 above the locking member is horizontal and is moved vertically into alignment with an aperture within the dispensing head or container. Alternatively, the locking member could be formed as a separate structure that is adhered to the side of the actuator. Proper functioning of the actuator may result when the locking member is raised to be in alignment with an aperture in the dispensing head or container. Alternatively, a plate that protrudes outwards from the container can be attached to the dispensing apparatus. The plate has one or more apertures through which the locking member can pass when correctly aligned.

In the starting position the locking member is misaligned with the said aperture(s) in the plate and the actuator cannot be operated. Raising the locking member vertically aligns the locking member with the aperture(s) in the plate and thus allows operation of the actuator converting the dispensing apparatus into the unlocked configuration. The locking member is biased to return back to the starting position when the actuator is released where it is in misalignment with the aperture(s) in the said plate. Such additional structures can be applied to most existing designs of dispensing apparatus. There is no need to make extensive structural modifications to existing dispensing apparatus.

### Example 3

The locking member could be hinged at the dispensing head or container, and not hinged at the actuator or vice versa ie hinged at the actuator and not fixed at the dispensing head or container (an example shown in FIG. 4). In the starting position the locking member is positioned such that it restricts or prevents movement of the actuator. To operate the dispensing apparatus, the user must flip the locking member upward, downwards or sideways thereby allowing the actuator to function. In FIG. 4a the locking member has been flipped upwards whilst the actuator is compressed, activating the dispensing apparatus. The key childproof feature is that the locking member returns back to the starting position once the actuator is released and returns to the lock configuration. This is due to the locking member being biased to return back to the starting position by elastic, sprung, magnetic or other means. A magnet may be positioned at the container end of the locking member. A second magnet is positioned on the actuator itself such that the magnets attract holding the locking member in the starting state. On flipping the locking member the user has to overcome the magnetic attraction to allow the locking member to be raised and the actuator operated. On release of the actuator, the locking member may fall by gravity for example and then be locked in place by the magnetic attraction described above. The locking member may itself not be biased to return its starting position in the instance where the actuator isd biased by a spring or other means. The attachment of the locking member to a biased member will return the locking member back to the starting or near starting position. Both the actuator and the locking member may be biased to return to the starting position

### Example 4

The locking member may be placed perpendicularly against the side of the actuator such that it overlaps the handle of the actuator and the dispensing head (FIG. 5). The locking member is enclosed in two guides, respectively provided in the actuator and the dispensing head. The operator can move the locking member up and down in the guides. The locking member is made in two parts or has a flexible joint which enables operation of the actuator when the joint of the locking member is positioned in a space between the guides.

### Example 5

The locking member may be comprised of a series of two or more segments having abatable faces that are arranged as shown in FIG. 6. These segments may be held together by for example an adhesive layer or flexible connection that joins the segments together. In the example shown in FIG. 6a the segments are rectangular in shape and are held together by an adhesive tape that is applied to one of the surfaces. When the segments are arranged as shown in FIG. 6a, the flexible connection is unflexed, the abuttable faces abut and the locking member retains its shape when compressed from both ends and does not significantly deform (FIG. 6a). The ends could be applied to two surfaces which are effectively kept apart. However if a force(s) are applied to the adhesive taped surface whilst the locking member is compressed at its ends as shown in FIG. 6b, the flexible connection is flexed, the abuttable faces are brought either totally or partly out of contact, and the locking member deforms into an arc or other shape. This force(s) is herein known as the secondary force. The secondary force may be perpendicular to the longitudinal axis of the locking member. In deforming, the distance between the two ends is allowed to be reduced. Segmented locking members may be utilised in a variety of circumstances where an aperture is to be controlled upon compression of the locking member from one or more ends in combination with the application of one or more secondary forces to the locking member as an aid to allow the locking member to become deformed. This provides the means for controlling the separation between two surfaces between which the locking member has been positioned.

One application of such a segmented locking member is its use in any structure with a actuator, for example a dispensing apparatus where the locking member is positioned between the actuator and the pump mechanism. When the locking member is in its starting position, the actuator is in its lock position and the locking member fills the gap between the actuator and the pump mechanism (FIG. 7). Compression of the actuator without a secondary force or indeed with insufficient secondary force applied to the locking member does not allow the actuator to be compressed as the locking member does not deform into an arc or other shape. In the correct use, the action of pulling the actuator in combination with the application of the secondary force(s) to the locking member allows the locking member to deform into an arc or some other shape and allows the actuator to be operated.

The locking member can be comprised of two or more segments that can vary in shape and size. The locking member can be biased to return back to its starting position in numerous ways. For example, elastic, spring, gravitational or magnetic means may be utilised. Such means may be present on one or more surfaces of the locking member or may run through the internal section of all or some of the segments of the locking member. The actuator may be designed to return back to its lock position by a spring or other means. In this instance the locking member if attached directly or indirectly to the actuator would return to its starting position by virtue of the movement of the biased actuator. Alternatively, the actuator itself may not be biased to return to its lock position, instead the locking member may be biased and if attached to the actuator would result in the actuator returning to the lock position. A combination of means may be used to return the locking member back to its starting position.

The segments themselves may have magnetic properties in all or some of the segments. In combination with the magnetic segments, other magnets may be used either at the container end or the actuator end of the dispensing apparatus. Use of magnetic materials allows the modulation of the force required to deform the locking member and thus alter the extent of the child proof properties of the apparatus.

Other means for linking the segments of the locking member include but are not limited to moulded male and female fitting. A single length of locking member may be spliced such that it comprises two or more segments which are joined by the material itself. For example a length of plastic may be partially cut into sections as shown in FIG. 8a such that sections remain joined to the material. A locking member is created having two or more segments which are joined together by the material itself. There is no need to apply a joining means to the segments. The circular apertures shown in FIG. 8a allow the material to bend or flex. The apertures do not need to be circular and could be of any shape.

Attachment of the locking member to the dispensing apparatus can be performed at the actuator and/or the dispensing head or container. There are various ways in which the locking member can be attached to the dispensing apparatus, some of which are described below. The segments of the locking member may be attached directly or indirectly to actuator as well as the dispensing head or container. The ends of the locking member may comprise a section(s) which has no segments; these are called the linking piece(s) as shown in FIG. 8b. The linking pieces may be rigid or flexible and may allow movement of the locking member when it is being deformed during correct operation of the actuator mechanism. On correct operation of the dispensing apparatus the space between the actuator and the pump mechanism is reduced. When the locking member is deformed into and arc or other shape, the linking pieces help accommodate the deformed locking member in the reduced space between the actuator and the pump mechanism. The linking piece may contain segments that are different in size or shape compared to the remainder of the segments. It is possible to attach the linking piece to the actuator or the dispensing head or container in various ways.

The segmented locking member may be moulded as an arc as shown in FIG. 8c. Here the segments are moulded as part of the material joining the segments together. On straightening such a moulded locking member, the segments will come together to form the locking member as seen in its starting position. The locking member will have elastic properties when it is in its starting position since it has been moulded in the form shown in FIG. 8c.

### Example 6

In yet another embodiment the locking member is fixed to both the dispensing head or container as well as the actuator, however it is hinged at a point between the actuator and the dispensing head or container (FIG. 9). On operation of the actuator the locking member bends at the hinged region. In this configuration the actuator can be operated easily as there is no child resistant feature. The dispensing apparatus is made to be child resistant by virtue of a brace moveable from a first position, wherein the brace prevents hinging of segments to a second position wherein the brace does not prevent hinging of the segments. The brace may comprise a sleeve wherein the sleeve may be slidably mounted on the locking member. In the first position, the sleeve is positioned over the hinge region of the locking member and prevents the bending of the locking member. The dispensing apparatus is in the locked configuration and it will not deliver the contents since the actuator cannot be actuated. During operation of the dispensing apparatus, the user slides the sleeve to the second position away from the hinged region of the locking member. On so doing, the actuator can be operated since the locking member is allowed to flex at the hinged region. The sleeve is automatically biased to return back to the first position where it covers the hinged region and prevents operation of the actuator, rendering the dispensing apparatus locked.

The sleeve can be prepared from any rigid material. Means for biasing the sleeve include a spring, elastic, magnetic or any other means that induce a natural bias for it to return back to its starting position. Notches, or protrusions present on the sleeve can help the user grip the sleeve to aid it to be slid. The locking member can be fixed to the dispensing apparatus at one end only or at both ends. One or more hinges can be present on the locking member. The locking member and sleeve can be prepared as a separate entity that is fixed to the dispensing apparatus by various means.

### Construction of Dispensing Apparatus

Means for fixing the locking member at one of its ends, for example to the dispensing head or container includes a permanent adhesive or weld. Such a permanent weld prevents the locking member from being moved horizontally, however may still allow some movement of the locking member if it was flexed up and down or side to side from the actuator end of the dispensing apparatus. Other means for holding the locking member at the container end of the dispensing apparatus include ball and socket type of attachments. Here the locking member could terminate as a ball at the container end of the dispensing apparatus. A socket present on the dispensing head or container could be used as a means for retaining the ball end of the locking member. A ball and socket type of arrangement allows for some movement of the locking member; however the locking member is prevented from being moved significantly vertically up or down. Additionally the locking member could be hingedly attached.

Further means for fixing or restraining the locking member at the dispensing head or container include a clip that fits around the body of the dispensing head or container. The clip could be made from plastic or other material, which is secured either permanently by an adhesive or held in place by friction or other means. The clip could be secured partially or totally around the neck of the container. The locking member could also be attached to a washer or collar which fits around the neck of the container over which the pump mechanism is applied. The locking member could also be removably fixed or held in place within a section created as part of the moulding process for preparation of the container or any other part of the dispensing apparatus.

The locking member can be comprised of any rigid material, natural or man made having properties that allow the proper functioning of the locking member in the manner described above.

Unless otherwise indicated, all numbers expressing quantities of ingredients, dimensions reaction conditions and so forth used in the specification and claims are to be understood as being modified in all instances by the term “about”.

In this application and the claims, the use of the singular includes the plural unless specifically stated otherwise. In addition, use of “or” means “and/or” unless stated otherwise. Moreover, the use of the term “including”, as well as other forms, such as “includes” and “included”, is not limiting. Also, terms such as “element” or “component” encompass both elements and components comprising one unit and elements and components that comprise more than one unit unless specifically stated otherwise.

Various embodiments of the disclosure could also include permutations of the various elements recited in the claims as if each dependent claim was a multiple dependent claim incorporating the limitations of each of the preceding dependent claims as well as the independent claims. Such permutations are expressly within the scope of this disclosure.

While the invention has been particularly shown and described with reference to a number of embodiments, it would be understood by those skilled in the art that changes in the form and details may be made to the various embodiments disclosed herein without departing from the spirit and scope of the invention and that the various embodiments disclosed herein are not intended to act as limitations on the scope of the claims. All references cited herein are incorporated in their entirety by reference.

The description of the present invention has been presented for purposes of illustration and description, but is not intended to be exhaustive or limiting of the invention to the form disclosed. The scope of the present invention is limited only by the scope of the following claims. Many modifications and variations will be apparent to those of ordinary skill in the art. The embodiment described and shown in the figures was chosen and described in order to best explain the principles of the invention, the practical application, and to enable others of ordinary skill in the art to understand the invention for various embodiments with various modifications as are suited to the particular use contemplated.

What is claimed is:

1. A dispensing apparatus comprising a dispensing head for a fluid, wherein the dispensing head comprises an actuator, a pump mechanism and a locking member, wherein said actuator is movable relative to the pump mechanism from a lock position to a first pump position and wherein the actuator is movable relative to the pump mechanism between a first pump position and a second pump position for actuating said pump mechanism, and wherein the dispensing apparatus is configurable into a locked configuration, in which the actuator is in the lock position and in which the locking member is braced between the actuator and the pump mechanism to prevent movement of the actuator from the lock position, and an unlocked configuration in which the locking member allows movement of the actuator from the lock position, and wherein the dispensing head is adapted to revert from the unlocked configuration to the locked configuration when the actuator is returned to the lock position.

2. The apparatus of claim 1 wherein the pump mechanism further comprises housing.

3. The apparatus of claim 1 further comprising a container, for containing the fluid to be dispensed, in fluid connection to said dispensing head.

4. The apparatus of claim 1 wherein the dispensing head is adapted to automatically revert from an unlocked configuration to a locked configuration by a biased means.

5. The apparatus of claim 4 wherein said biased means comprises at least one of a spring, elastic, gravitational and magnetic means.

6. The apparatus of claim 1 wherein the locking member comprises two or more segments having abuttable faces and a flexible connection between the segments, and wherein in the locked configuration the flexible connection is unflexed and the abuttable faces abut to brace the locking member between the actuator and the pump mechanism, and in the unlocked configuration the flexible connection is flexed to bring the abuttable faces out of contact, allowing flexing of the locking member.

7. The apparatus of claim 6 wherein the flexible connection is flexed by application of a force perpendicular to the longitudinal axis of the locking member.

8. The apparatus of claim 7 wherein the flexible material comprises a flexible strip along one side of the locking member, and wherein the perpendicular force is applied to the flexible strip.

9. The apparatus of claim 6 wherein the segments comprise a substantially non-compressible material.

10. The apparatus of claim 6 wherein the segments comprise magnetic material.

11. The apparatus of claim 7 wherein said locking member further comprises a linking piece at either end of said locking member, wherein said linking piece comprises a length of said flexible strip deposed between the actuator, dispensing head or container and the adjacent segment.

12. The apparatus of claim 1 wherein the locking member comprises two or more hinged segments, further comprising a brace movable from a first position wherein the brace prevents hinging of the segments, to a second position wherein the brace does not prevent hinging of the segments.

13. The apparatus of claim 12 wherein the brace is automatically returnable to a position over the hinge when the actuator is returned to the lock position.

14. The apparatus of claim 12 wherein the brace comprises a sleeve.

15. The apparatus of claim 14 wherein the sleeve is slidably mounted on the locking member.

16. The apparatus of claim 14 wherein the sleeve further comprises a formation to facilitate the manual movement of said sleeve to a position away from the hinge.

17. The apparatus of claim 1 in which the locking member is rigid against movement of the actuator from the lock position, further comprising an aperture in one or more of the actuator, dispensing head and container, adapted to receive said locking member when the dispensing apparatus is configured to the unlocked configuration.

18. The apparatus of claim 17 wherein said aperture is in the dispensing head or container and the locking member is attached at a first end to the actuator.

19. The apparatus of claim 18 wherein the locking member is movably attached to said actuator, and wherein the dispensing apparatus is configurable from the locked configuration, wherein the locking member is out of alignment with the aperture, to the unlocked configuration, wherein the locking member is in alignment with the aperture and can be received by the aperture.

20. The apparatus of claim 18 wherein the locking member is attached to the actuator such that a portion of the locking member protrudes from the outer surface of the actuator, allowing manual manipulation of said locking member relative to the aperture.

21. The apparatus of claim 17 wherein the aperture is in the actuator and wherein the locking member is attached at a first end to the dispensing head or container.

22. The apparatus of claim 21 wherein the second end of the locking member is moveable into alignment with the aperture and can be received by the aperture.

23. The apparatus of claim 21 further comprising a movable shutter over said aperture configured to close and open said aperture, and wherein the dispensing apparatus is configurable from the locked configuration wherein the aperture is closed, to the unlocked configuration wherein the aperture is open.

24. The apparatus of claim 23 wherein the shutter further comprises a formation to facilitate the movement of said shutter to allow the opening of said aperture.

25. The apparatus of claim 23 wherein the shutter further comprises an aperture, and wherein the dispensing apparatus is configurable from the locked configuration, wherein the shutter aperture is out of alignment with the actuator aperture, to the unlocked configuration, wherein the shutter aperture is in alignment with the actuator aperture.

26. The apparatus of claim 23 wherein the shutter is slidably mounted to said actuator.

27. The apparatus of claims 23 wherein the shutter is configured to allow vertical movement of the shutter relative to the actuator.

28. The apparatus of claim 23 wherein the shutter is rotatably mounted to said actuator.

29. The apparatus of claim 23 wherein the shutter is biased to automatically close the actuator aperture when the actuator returns to the lock position.

30. The apparatus of claim 29 wherein the biased means comprises at least one of a spring, elastic, gravitational and magnetic means.

31. The apparatus of claim 1 wherein the locking member is rigid against movement of the actuator from the lock position and is hingedly attached at a first end to one of the dispensing head, container or actuator.

32. The apparatus of claim 31 wherein the locking member is movable about said hinge from a position in which it extends between the actuator and the pump mechanism, to an unlock position in which it allows movement of the actuator from the lock position.

33. The apparatus of claim 32 wherein the actuator further comprises a groove in the surface adjacent to the dispensing head or container for receiving the locking member when it is rotated to the unlock position.

34. The apparatus of claim 35 wherein the locking member is attached to the actuator.
